(19) United States
(12) Patent Application Publication
(10) Pub. No.: US 2022/0301530 A1
(43) Pub. Date: Sep. 22, 2022

(54) INFORMATION PROCESSING DEVICE, ELECTRONIC MUSICAL INSTRUMENT, AND INFORMATION PROCESSING METHOD

(71) Applicant: CASIO COMPUTER CO., LTD., Tokyo (JP)

(72) Inventor: Makoto DANJYO, Tokyo (JP)

(73) Assignee: CASIO COMPUTER CO., LTD., Tokyo (JP)

(21) Appl. No.: 17/694,412

(22) Filed: Mar. 14, 2022

(30) Foreign Application Priority Data
Mar. 18, 2021 (JP) 2021-045284
Jul. 16, 2021 (JP) 2021-117857
Nov. 24, 2021 (JP) 2021-190167

(51) Int. Cl. G10H 1/02

(52) U.S. Cl. CPC G10H 1/02; G10H 2250/455; G10H 2250/491; G10H 2210/131

(57) ABSTRACT

A voice synthesis device includes at least one processor, implementing a first voice model and a second voice model different from the first voice model, the at least one processor performing the following: receiving data indicating a specified pitch; and causing the first voice model to output a first data and the second voice model to output a second data, and generating and outputting a third data corresponding to the specified pitch based on the first data and second data.

### BACKGROUND OF THE INVENTION

### Technical Field

The present invention relates to an information processing device for outputting synthesized voice such as a singing voice, an electronic musical instrument, and an information processing method.

### Background Art

A conventional technique for synthesizing high-quality singing voice sounds corresponding to a lyrics data is known in which, based on stored lyrics data, the corresponding parameters and tone combination parameters are read from a phoneme database, the corresponding voice is synthesized and output by a formant synthetic sound source unit, and the unvoiced consonants are produced by a PCM sound source. (for example, see Japanese Patent No. 3233306).

### SUMMARY OF THE INVENTION

The human singing range is generally about two octaves. Therefore, when the above-mentioned conventional technique is applied to an electronic keyboard having 61 keys, if an attempt is made to assign the singing voice of a single person to all the keys, a range that cannot be covered by one singing voice exists.

On the other hand, even if an attempt is made to cover with a plurality of singing voices, an unnatural feeling of strangeness occurs at the place where the character of the singing voice is switched.

Therefore, it is an object of the present invention to enable the generation of voice data suitable for such a wide range.

In one aspect of the present invention, an information processing device detects a designated sound pitch, and, based on a first data of a first voice model and a second data of a second voice model different from the first voice model, generates a third data corresponding to the detected designated pitch.

According to the present invention, it is possible to generate voice data suitable for a wide range of pitches.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides an information processing device for voice synthesis, comprising: at least one processor, implementing a first voice model and a second voice model different from the first voice model, the at least one processor performing the following: receiving data indicating a specified pitch; and causing the first voice model to output a first data and the second voice model to output a second data, and generating and outputting a third data corresponding to the specified pitch based on the first data and second data.

In another aspect, the present disclosure provides an electronic musical instrument, comprising: a performance unit for specifying a pitch; and the above-described information processing device including the at least one processor, the at least one processor receiving the data indicating the specified pitch from the performance unit.

In another aspect, the present disclosure provides an electronic musical instrument, comprising: a performance unit for specifying a pitch; a processor; and a communication interface configured to communicates with an information processing device that is externally provided, the information processing device implementing a first voice model and a second voice model different from the first voice model, wherein the processor causes the communication interface to transmit data indicating the pitch specified by the performance unit to the information processing device and receive from the information processing device data generated in accordance with the first voice model and the second voice model that corresponds to the specified pitch, and wherein the processor synthesizes singing voice based on the data received from the information processing device and causes the synthesized singing voice to output.

In another aspect, the present disclosure provides a method performed by at least one processor in an information processing device, the at least one processor implementing a first voice model and a second voice model different from the first voice model, the method comprising, via the at least one processor: receiving data indicating a specified pitch; and causing the first voice model to output a first data and the second voice model to output a second data, and generating and outputting a third data corresponding to the specified pitch based on the first data and second data.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is an operation explanatory diagram of a first embodiment.

FIG. 2 is a flowchart showing an operation outline of the first embodiment.

FIG. 3 is a diagram showing an example of the appearance of an electronic keyboard instrument according to the second embodiment.

FIG. 4 is a block diagram showing a hardware configuration example of a control system of the electronic keyboard instrument according to the second embodiment.

FIG. 5 is a block diagram showing a configuration example of the voice synthesis LSI according to the second embodiment.

FIGS. 6A-6C are operation explanatory diagrams of a formant interpolation processing unit according to the second embodiment.

FIG. 7 is a flowchart showing an example of the main process of singing voice synthesis executed by the CPU in the second embodiment.

FIG. 8 is a flowchart showing an example of voice synthesis processing executed by the voice synthesis unit of the voice synthesis LSI in the second, third, and fourth embodiments.

FIG. 9 is a flowchart showing a detailed example of the singing voice optimization processing executed by the formant interpolation processing unit of the voice synthesis LSI 405 in the second, third, and fourth embodiments.

FIG. 10 is a diagram showing a connection mode of a third embodiment in which the voice synthesizer and the electronic keyboard instrument operate separately.

FIG. 11 is a diagram showing a hardware configuration example of the voice synthesis unit in the third embodiment in which the voice synthesis unit and the electronic keyboard instrument operate separately.

FIG. 12 is a flowchart showing an example of the main process of singing voice synthesis in the third and fourth embodiments.

FIG. 13 is a diagram showing a connection mode of a fourth embodiment in which a part of the voice synthesis unit and the electronic keyboard instrument operate separately.

FIG. 14 is a diagram showing a hardware configuration example of the voice synthesis unit in the fourth embodiment in which a part of the voice synthesis unit and the electronic keyboard instrument operate separately.

FIG. 15 is a block diagram showing a configuration example of a part of the voice synthesis LSI and the voice synthesis unit according to the fourth embodiment.

### DETAILED DESCRIPTION OF EMBODIMENTS

Hereinafter, embodiments for carrying out the present invention will be described in detail with reference to the drawings. First, the first embodiment will be described.

The range of human singing voice, which is an example of voice, is generally about two octaves. On the other hand, for example, when an attempt is made to synthesize a singing voice function as an information processing device, there is a possibility that the designation of the sound range exceeds the human singing voice range and extends to, for example, about 5 octaves.

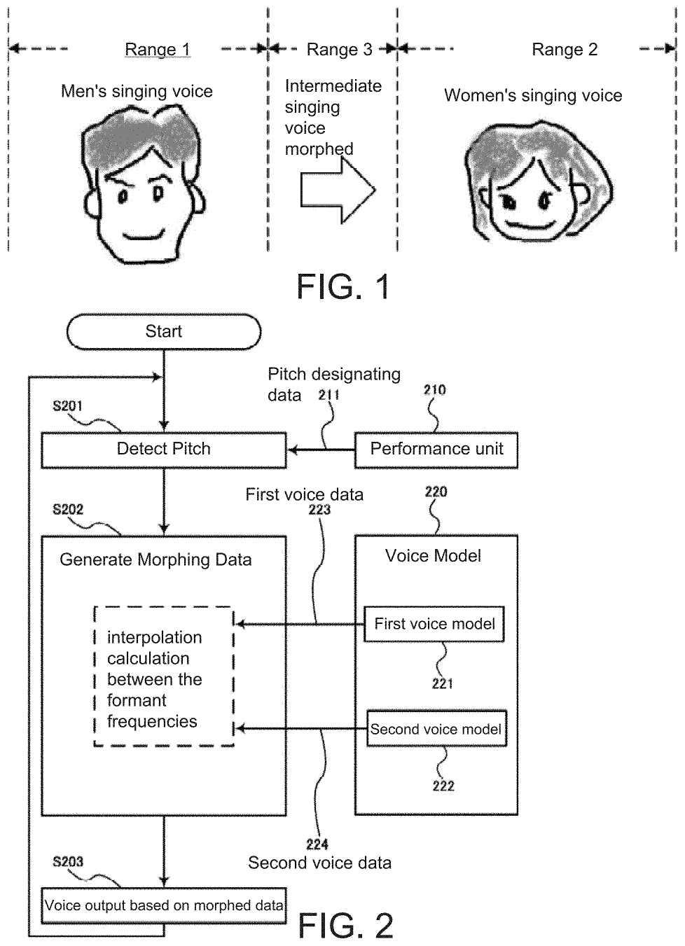

Therefore, in the first embodiment, for example, as shown in FIG. 1, a first singing voice model that models a male singing voice having a low pitch sound is assigned to the sound range 1 for two octaves on the bass side, and a second singing voice model that models, for example, a female singing voice with a high pitch sound is assigned to the sound range 2 for two octaves on the treble side.

Further, in the first embodiment, as shown in FIG. 1, for example, in the range 3, which is sandwiched between the range 1 and the range 2 and which has about two octaves in the center not overlapping with the range 1 or 2, a singing voice between men and women morphed from the first singing voice in the range 1 and the second signing voice in the range 2 is assigned.

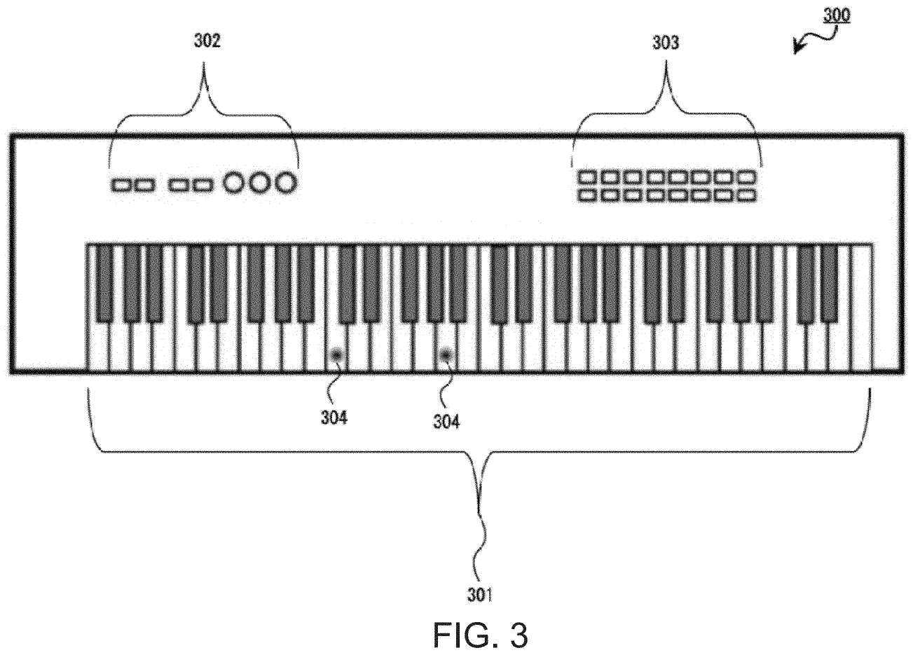

FIG. 2 is a flowchart showing an example of the voice generation process (for example, a singing voice generation process) executed by at least one processor (hereinafter referred to as “processor”) of the information processing device of the first embodiment.

First, the processor detects a specified pitch (step S201). When the information processing apparatus/device is implemented as, for example, an electronic musical instrument, the electronic musical instrument includes, for example, a performance unit 210. Then, for example, the processor detects the specified pitch based on the pitch designating data 211 detected by the performance unit 210.

Here, the information processing device includes, for example, a voice model 220 which is a database system. Then, the processor reads out the first voice data (first data) 223 of the first voice model 221 and the second voice data (second data) 224 of the second voice model 222 from, for example, the database system of the voice model 220. Then, the processor generates morphing data (third data) based on the first voice data 223 and the second voice data 224 (step S202). More specifically, when the voice model 220 is a human singing voice model, the processor generates the morphing data by the interpolation calculation between the formant frequencies of the first singing voice data corresponding to the first voice data 223 and the formant frequencies of the second singing voice data corresponding to the second voice data 224.

Here, for example, the first voice model 221 stored as the voice model 220 may include a trained (acoustic) model that has learned a first voice (for example, the singing voice of a first actual singer), and the voice model 222 stored as the voice model 220 may include a trained (acoustic) model that has learned a second voice (for example, the singing voice of a second actual singer).

The processor outputs voice synthesized based on the morphing data generated in step S202 (step S203).

Here, for example, the pitch detected in step S201, as described above, can be in a non-overlapping range between the first range corresponding to the first voice model 221 and the second range corresponding to the second voice model 222. Then, the morphing data generated in step S202 may be generated when there is no voice model corresponding to the range of a designated song. However, even if the first range and the second range overlap with each other, the present invention may be applied so as to generate morphing data based on the voice data of the respective plural voice models.

In the voice generation process of the first embodiment described above, if the music belongs to, for example, the bass side range 1 of FIG. 1, the processor infers the formant frequencies from the first singing voice model corresponding to the first voice model 221 which models men's singing voice of a human male assigned to that range 1, and outputs corresponding singing voice in the first range.

Further, if the music belongs to, for example, the treble side range 2 of FIG. 1, the processor infers the formant frequencies from the second singing voice model corresponding to the second voice model 222 which models women's singing voice of a human female assigned to that range 2, and outputs corresponding singing voice in the second range.

On the other hand, if the music belongs to, for example, the range 3 that is between the ranges 1 and 2 of FIG. 1, by way of the process at step S202 of FIG. 2, the processor generates morphing data based on the first singing voice data corresponding to the first voice date 223 of the first singing voice model corresponding the first voice model 221, which models men's singing voice, and the second singing voice data corresponding to the second voice date 223 of the second singing voice model corresponding the second voice model 222, which models women's singing voice, and outputs the resulting singing voice.

As a result of the above processing, it is possible to output, for example, a singing voice having an optimum range that matches the key range of the music.

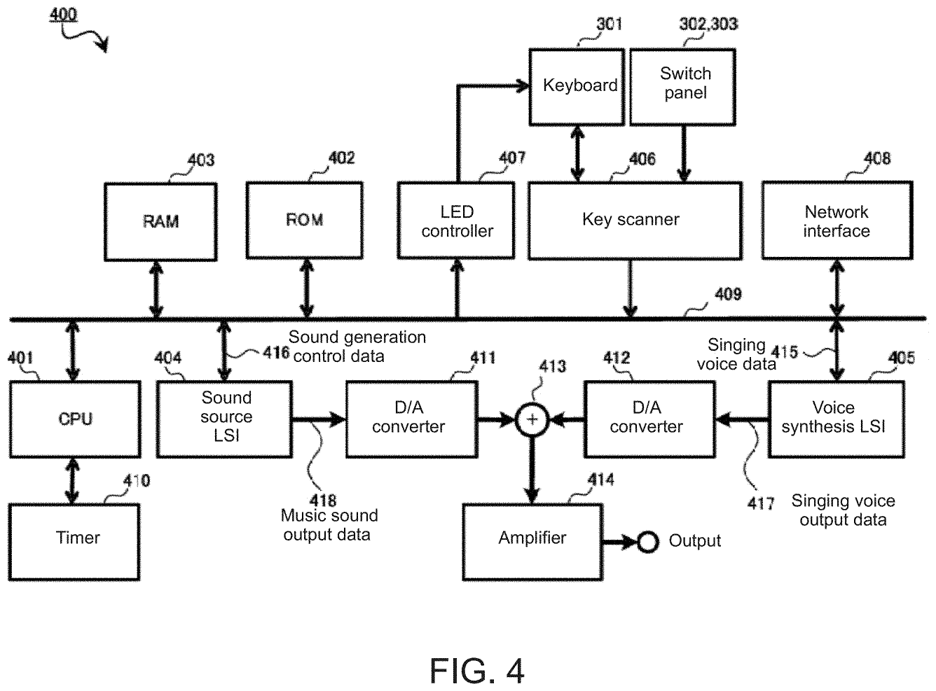

Next, a second embodiment will be described. In the second embodiment, singing voice models (acoustic models) that model human singing voices are used as models for the voice model 220 of FIG. 2. FIG. 3 is a diagram showing an external appearance of an electronic keyboard instrument 300 according to the second embodiment. The electronic keyboard instrument 300 includes a keyboard 301 composed of a plurality of keys as a performance unit, a first switch panel 302 for instructing various settings, such as volume specification, automatic lyrics playback tempo setting, and automatic lyrics playback start, and a second switch panel 303 for selecting songs, selecting musical instrument tones, and the like. Further, each key of the keyboard 301 has an LED (Light Emitting Diode) 304. The LED 304 glows at maximum brightness when the key is the next key to be played during lyrics autoplay, and glows at half the brightness when the key is to be played next to the key having the maximum brightness during lyrics autoplay. Further, although not particularly shown, the electronic keyboard instrument 300 is provided with a speaker for emitting a musical sound and/or a singing voice generated by the user performance on the back surface portion, the side surface portion, the back surface portion, or the like.

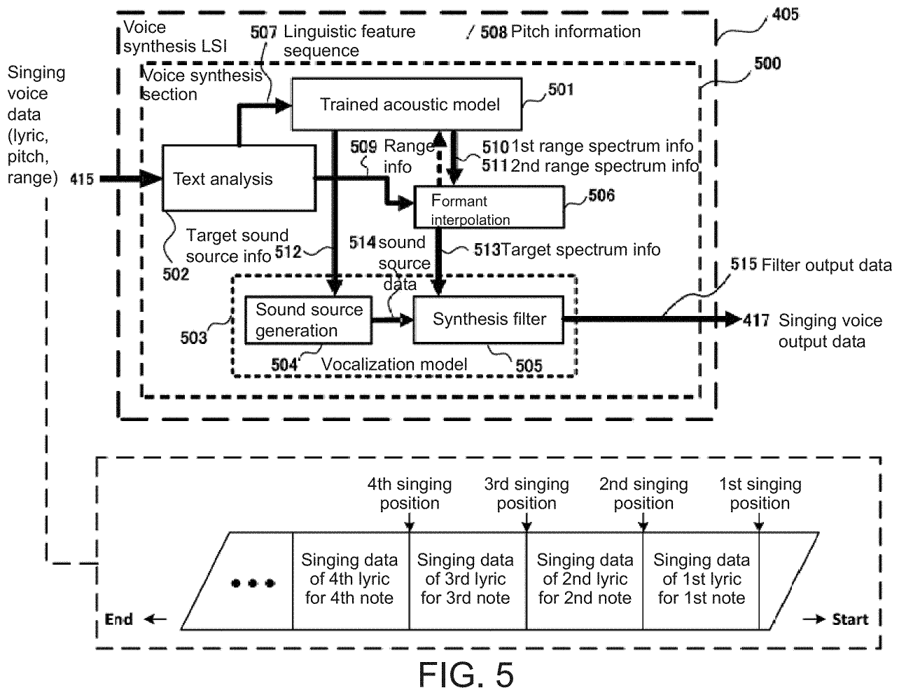

FIG. 4 is a diagram showing a hardware configuration example of a control system 400 of the electronic keyboard instrument 300 of FIG. 3 in the second embodiment. In FIG. 4, the control system 400 includes a CPU (central processing unit) 401, a ROM (read-only memory) 402, a RAM (random access memory) 403, a sound source LSI (large-scale integrated circuit) 404, a voice synthesis LSI (voice synthesizer) 405, the keyboard 301 of FIG. 3, a key scanner 406 to which the first switch panel 302 and the second switch panel 303 are connected, an LED controller 407 to which the LED 304 of each key on the keyboard 301 of FIG. 3 is connected, and a network interface 408 for exchanging MIDI data and the like with an external network, which are respectively connected to a system bus 409. Further, a timer 410 for controlling the sequence of automatic playback of singing voice data is connected to the CPU 401. Further, the music sound output data 418 and the singing voice output data 417 output from the sound source LSI 404 and the voice synthesis LSI 405, respectively, are converted into an analog music sound output signal and an analog singing voice output signal by the D/A converters 411 and 412, respectively. The analog music sound output signal and the analog singing voice output signal are mixed by the mixer 413, amplified by the amplifier 414, and are output from a speaker or an output terminal.

The CPU 401 executes control operations of the electronic keyboard instrument 300 shown in FIG. 3 by executing a control program stored in the ROM 402 while using the RAM 403 as the work memory. In addition to the control program and various control data, the ROM 402 stores performance guide data including lyrics data, which will be described later.

The timer 410 may be mounted in the CPU 401, and counts, for example, the progress of automatic playback of performance guide data in the electronic keyboard instrument 300.

The sound source LSI 404 reads, for example, musical sound waveform data from a waveform ROM (not shown), and outputs the data to the D/A converter 411 in accordance with the sound generation control instruction from the CPU 401. The sound source LSI 404 has the ability to produce up to 256 voices at the same time.

When the voice synthesis LSI 405 is given with the lyrics information, which is the text data of the lyrics, and the pitch information about the pitch, as the singing voice data 415 from the CPU 401, the voice synthesis LSI 405 synthesizes the singing voice output data 417 which is the voice data of the corresponding singing voice, and outputs the data 417 to the D/A converter 412.

The key scanner 406 constantly scans the key press/release state of the keyboard 301 of FIG. 3 and the switch operation states of the first switch panel 302 and the second switch panel 303, and interrupts the CPU 401 to inform the state changes, if any.

The LED controller 407 is an IC (integrated circuit) that controls the display state of the LED 304 in each key of the keyboard 301 of FIG. 3.

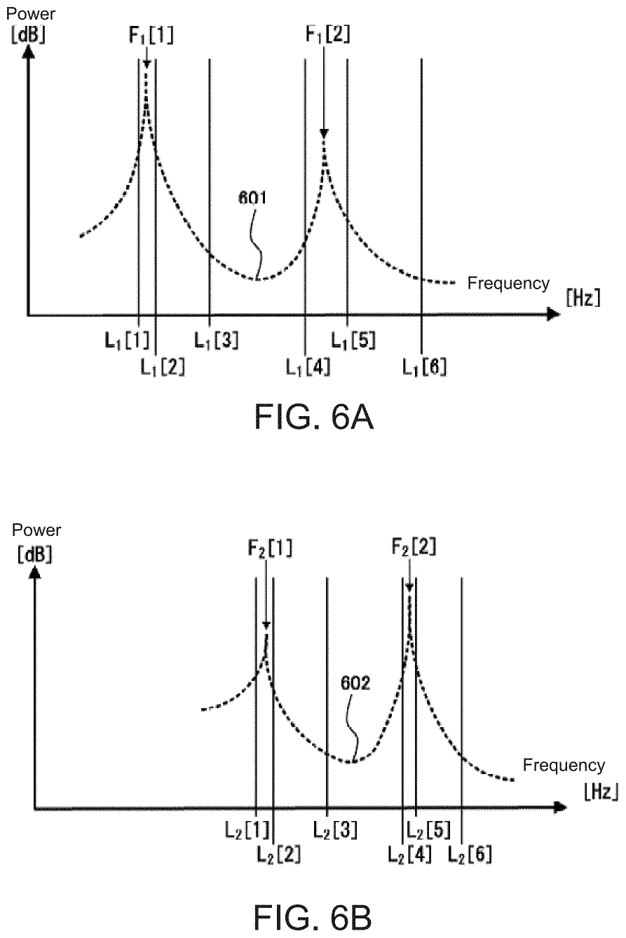

FIG. 5 is a block diagram showing a configuration example of a voice synthesis process 500 in the second embodiment. The voice synthesis process 500 is a function executed by the voice synthesis LSI 405 of FIG. 4 in this embodiment. In this disclosure, however, the term “unit”, “process”, “section” may generally be interchangeably used to indicate the corresponding functionality, as the case may be, and each such feature may be realized by appropriate computer program, subroutine or functions of program, and/or hardware and any combinations thereof.

The voice synthesis process 500 synthesizes and outputs the singing voice output data 417 based on the singing voice data 415 that includes the lyrics information, the pitch information, and the range information instructed from the CPU 401 of FIG. 4. The voice synthesis process 500 synthesizes and outputs the singing voice output data 417 that infers the singing voice of a singer(s) based on the target sound source information 512, which is output from the acoustic model 501 in response to the singing voice data 415 including the lyrics information, the pitch information, and the sound range information input by the CPU 401 with respect to the acoustic model set in the acoustic model unit 50, and based on the target spectrum information 513 which is output from the acoustic model 501 through the formant interpolation process 506. The voice synthesis process 500 is implemented based on, for example, the technique described in Japanese Patent No. 6610714 as the base.

The details of the basic operation of the voice synthesis process 500 are disclosed in the above patent document, but operations of the voice synthesis process 500 of this embodiment that include operations unique to the second embodiment will be described below.

The voice synthesis process 500 includes a text analysis process 502, an acoustic model process 501, a vocalization model process 503, and a formant interpolation process 506. The formant interpolation process 506, for example, is a unique part in the second embodiment.

In the second embodiment, the voice synthesis process 500 performs statistical voice synthesis in which the singing voice output data 417 corresponding to the singing voice data 415 that include the lyrics, which are the texts of the lyrics, the pitch, and the sound range is generated by inference using an acoustic model set in the acoustic model 501, which is a statistical model.

The text analysis process 502 receives the singing voice data 415 including information on lyrics, pitch, range, etc., designated by the CPU 401 of FIG. 4, and analyzes the data. As a result, the text analysis process 502 generates a linguistic feature sequence 507 representing phonemes, a part of speech, a word, etc., corresponding to the lyrics in the singing voice data 415, and pitch information 508 corresponding to the pitch in the singing voice data 415, and forwards them to the acoustic model 501.

Further, the text analysis unit 502 generates range information 509 indicating the sound range in the singing voice data 415 and gives it to the formant interpolation processing unit 506. If the range indicated by the range information 509 is within the range of the first range, which is the current or default range, the formant interpolation processing unit 506 requests the acoustic model unit 501 to provide the spectrum information 510 of the first range (hereinafter, “first range spectrum information 510”).

The first range spectrum information 510 may be referred to as first spectrum information, first spectrum data, first voice data, first data, and the like.

On the other hand, if the range indicated by the range information 509 is not within the range of the first range, which is the current range, and is within another preset second range, the formant interpolation processing unit 506 change the value of the range setting variable to indicate the second range and requests the acoustic model unit 501 to provide the second range spectrum information 511.

On the other hand, if the range indicated by the range information 509 is not included in the first or second range, but is in a range between the first range and the second range, the formant interpolation processing unit requests the acoustic model unit 501 to provide both the first range spectrum information 510 and the second range spectrum information 511.

The second range spectrum information 511 may be referred to as second spectrum information, second spectrum data, second voice data, second data, or the like.

The acoustic model unit 501 receives the above-mentioned linguistic feature sequence 507 and the pitch information 508 from the text analysis unit 502, and also receives the above-mentioned request specifying the above-mentioned range(s) from the formant interpolation processing unit 506.

As a result, the acoustic model unit 501 uses an acoustic model(s) that has been set as a trained result by machine learning, for example, and infers the first range spectrum and/or the second range spectrum that corresponds to the phoneme that maximizes the generation probability, and provide them to the formant interpolation processing unit 506 as the first range spectrum information 510 and/or the second range spectrum information 511.

Further, the acoustic model unit 501 infers a sound source corresponding to the phoneme that maximizes the generation probability by using the acoustic model, and provide it as the target sound source information 512 to the sound source generation unit 504 in the vocalization model unit 503.

The formant interpolation processing unit 506 provides the first range spectrum information 510 or the second range spectrum information 511, or spectrum information obtained by interpolating the first range spectrum information 510 and the second range spectrum information 511 (hereinafter referred to as “interpolated spectrum information”) to the synthesis filter unit 505 in the vocal model unit 503 as the target spectrum information 513.

The target spectrum information 513 may be referred to as morphing data, third data, or the like when it represents interpolated spectrum information.

The vocalization model unit 503 receives the target sound source information 512 output from the acoustic model unit 501 and the target spectrum information 513 output from the formant interpolation processing unit 506, and generates the singing voice output data 417 corresponding to the singing voice data 415. The singing voice output data 417 is output from the D/A converter 412 of FIG. 4 through the mixer 413 and the amplifier 414, and is emitted from a speaker, for example.

The acoustic features output by the acoustic model unit 501 include spectrum information modeling the human vocal tract and sound source information modeling the human vocal cords. As parameters of the spectrum information, for example, a line spectrum pair (Line Spectral Pairs: LSP) that can efficiently model a plurality of formant frequencies that are human voice tract characteristics, a line spectrum frequency (Line Spectral Frequencies: LSF), or a Mel LSP (hereinafter referred to as “LSP”) or the like that is an improvement of these models can be adopted. Therefore, the first and second range spectrum information 510/511 output from the acoustic model unit 501, and the target spectrum information 513 output from the formant interpolation processing unit 506 may be frequency parameters based on the above-mentioned LSP, for example.

Cepstrum or mel cepstrum may be adopted as another example of the parameters of the spectrum information.

As the sound source information, the fundamental frequency (F0) indicating the pitch frequency of human voice and its power values (in the case of voiced phonemes) or the power value of white noise (in the case of unvoiced phonemes) can be adopted. Therefore, the target sound source information 512 output from the acoustic model unit 501 can be the parameters of F0 and the power values as described above.

The vocalization model unit 503 includes the sound source generation unit 504 and the syntheses filter unit 505. The sound source generation unit 504 is a portion that models a human voice cords, and by sequentially receiving a series of target sound source information 512 input from the acoustic model unit 501, generates the sound source data 514 constituted a pulse train periodically repeated with the fundamental frequency (F0) and its power values included in the target sound source information 512 (in the case of a voiced phoneme), for example, or white noise having power values included in the target sound source information 512 (in the case of an unvoiced phoneme), or a mixed signal thereof.

The synthesis filter unit 505 is a part that models the human vocal tract, and constructs an LSP digital filter that models the vocal tract based on the LSP frequency parameters included in the target spectrum information 513 that is sequentially input from the acoustic model unit 501 via the formant interpolation processing unit 506. When the digital filter is excited using the sound source input data 514 input from the sound source generation unit 504 as an excitation source signal, the filter output data 515, which is a digital signal, is output from the synthesis filter unit 505. This filter output data 515 is converted into an analog singing voice output signal by the D/A converter 412 of FIG. 4, and then mixed with an analog music output signal output from the sound source LSI 404 via the D/A converter 411 by the mixer 413. Then, after the mixed signal is amplified by the amplifier 414, it is output from a speaker or an output terminal.

The sampling frequency for the singing voice output data 417 is, for example, 16 KHz (kilohertz). Further, when, for example, the LSF parameters obtained by LSP analysis processing are adopted as the parameters of the first sound range spectrum information 510, the second sound range spectrum information 511, and the target spectrum information 513, the update frame period is, for example, 5 milliseconds. The analysis window length is, for example, 25 milliseconds, the window function is, for example, a Blackman window, and the analysis order is, for example, 10th order.

An outline of the overall operation of the second embodiment under the configurations of FIGS. 3, 4, and 5 will be described. First, the CPU 401 guides the performer to play music based on the performance guide data including at least the lyrics information, the pitch information, and the timing information. Specifically, in FIG. 4, the CPU 401 sequentially reads out a series of performance guide data sets including at least lyrics information, pitch information, and timing information for automatic playback stored in ROM 402, which is a memory, and automatically plays back the lyrics information and the pitch information included in the set of performance guide data at the timing corresponding to the timing information included in the set of performance guide data. The playback timing can be controlled, for example, based on interrupt processing by the timer 410 in FIG. 4 synchronized with a preset playing tempo.

At that time, the CPU 401 indicates keys to be played on the keyboard 301 corresponding to the pitch information to be automatically played so as to provide the user with a guidance for music practice (performance practice)—that is, the user's practice of pressing appropriate keys in synchronization with the automatic playback. More specifically, in the process of this performance guide, in synchronization with the timing of the automatic playback, the CPU 401 causes the LED 304 of the key to be played next to lit with strong brightness, for example, maximum brightness and causes the LED 304 of the key to be next played after the maximumly illuminated key to lit with weak brightness, for example, half of the maximum brightness.

Next, the CPU 401 acquires performance information, which is information related to performance operations in which the performer presses or releases the key(s) on the keyboard 301 of FIG. 3 in accordance with the performance guide.

Subsequently, if the key press timing (performance timing) of the keyboard 301 and the pressed key pitch (performance pitch) by the user performing the performance lesson correctly correspond to the timing information and the pitch information, respectively, that are automatically played back, the CPU 401 causes the lyrics information and pitch information to be automatically played back to be input into the text analysis unit 502 of FIG. 5, as singing voice data 415, at that key press timing. As a result, as described above, the digital filter of the synthesis filter unit 505, which is formed based on the target spectrum information 513 outputted from the acoustic model 501 through the formant interpolation processing unit 506, is excited by the sound source input data 514 output by the sound source generation unit 504 in which the target sound source information 512 output from the sound model unit 501 is set. Then, the synthesis filter unit 505 outputs the filter output data 515 as the singing voice output data 417 of FIG. 4.

The singing voice data 415 may contain at least one of lyrics (text data), syllable types (start syllable, middle syllable, end syllable, etc.), lyrics index, corresponding voice pitch (correct voice pitch), and corresponding voicing period (for example, voice start timing, voice end timing, voice duration) (correct voicing period).

For example, as illustrated in FIG. 5, the singing voice data 415 may include the singing voice data of the nth lyrics corresponding to the nth (n=1, 2, 3, 4, . . . ) note and information on prescribed timing at which the nth note is to be played back (nth singing voice playback position/nth singing position).

The singing voice data 415 may include information (data in a specific audio file format, MIDI data, etc.) for playing the accompaniment (song data) corresponding to the lyrics. When the singing voice data is presented in the SMF format, the singing voice data 415 may include a track chunk in which data related to singing voice is stored and a track chunk in which data related to accompaniment is stored. The singing voice data 415 may be read from the ROM 402 to the RAM 403. The singing voice data 415 has been stored in a memory (for example, ROM 402, RAM 403) before the performance.

The electronic keyboard instrument 300 may control the progression of automatic accompaniment based on events indicated by the singing voice data 415 (for example, a meta event (timing information) indicating the sound generation timing and pitch of lyrics, a MIDI event indicating note-on or note-off, or a meta event indicating the time signature).

Here, in the acoustic model unit 501, for example, an acoustic model(s) of a singing voice is formed as a learning result by machine learning. But as described above in the first embodiment, the human singing voice range is generally about two octaves. On the other hand, for example, 61 keys shown as the keyboard 301 in FIG. 3 extend over 5 octaves.

Therefore, in the second embodiment, of the 51 keys in the keyboard 301, an acoustic model (voice model) that is formed as a result of machine-learning a male singing voice having a low pitch sound, for example, is assigned to the key area 1 for two octaves on the bass side of the 61-key keyboard 301, and another acoustic model (voice model) that is formed as a result of machine-learning a female singing voice having a high pitch sound, for example, is assigned to the key area 2 for two octaves on the treble side.

Further, in the second embodiment, of the 61 key keyboard 301, a singing voice between men and women that is morphed from the first range singing voice of the key area 1 and the second range singing voice of the key area 2 is assigned to the key area 3 of the central two octaves.

Here, the singing voice data 415 loaded in advance from the ROM 402 to the RAM 403 may include, as the first meta event, for example, key area data that indicates which key area out of the key areas 1, 2, and 3 shown in FIG. 1, the entire music including the singing voice data 415 belongs to on average. Then, the text analysis unit 502 of FIG. 5 may receive the key area data from the CPU 201 as a part of the singing voice data 415 at the start of the singing voice synthesis. Then, the text analysis unit 502 may provide the range information 509 corresponding to the key area data to the formant interpolation processing unit 506 at the start of singing voice synthesis.

At the start of singing voice synthesis, the formant interpolation processing unit 506 determines which range of the key ranges 1, 2, and 3 exemplified in FIG. 1 the range indicated by the range information 509 belongs to. Then, if the formant interpolation processing unit 506 determines that the range indicated by the sound source information 319 belongs to one of the key areas 1 and 2 of FIG. 1, the formant interpolation processing unit 506 requests the acoustic model unit 501 to access the acoustic model of that specified sound range.

As a result, the acoustic model unit 501 uses the acoustic model of the corresponding first or second range requested by the formant interpolation processing unit 506 since the start of singing voice synthesis, and infers spectrum corresponding to phenome that makes generation probability maximum with respect to the linguistic feature sequence 507 and the pitch information 508 received from the text analysis unit 502. The inferred spectrum is then given to the formant interpolation processing unit 506 as the first/second range spectrum information 510/511.

Therefore, in the above-mentioned control operation, if the music belongs to the key area 1 on the bass side of the keyboard 301 of FIG. 3 as a whole, the acoustic model unit 501 infers the spectrum using the acoustic model (voice model) that has been assigned to the key area 1 in advance, and outputs the corresponding first range spectrum information 510. Then, the formant interpolation processing unit 506 provides the first range spectrum information 510 output from the acoustic model unit 501 as the target spectrum information 513 to the synthesis filter unit 505 in the vocalization model unit 503.

On the other hand, if the music as a whole belongs to, for example, the key area 2 on the high sound side of FIG. 1, the acoustic model unit 501 infers the spectrum from the acoustic model (voice model) of, for example, a feminine singing voice assigned in advance to the key area 2, and outputs the corresponding second range spectrum information 511. Then, the formant interpolation processing unit 506 provides the second range spectrum information 510 output from the acoustic model unit 501 as the target spectrum information 513 to the synthesis filter unit 505 in the vocalization model unit 503.

On the other hand, if the music as a whole belongs to, for example, the key area 3 in the middle of FIG. 1, the formant interpolation processing unit 506 sets the key areas 1 and 2 on both sides of the key area 3 as the first range and the second range, respectively and requests the acoustic model unit 501 to access both the acoustic models of the first range and the second range.

In response, the acoustic model unit 501 outputs two spectrum information: the first range spectrum information 510 and the second spectrum information 511. The first range spectrum information 510 corresponds to the spectrum inferred from the acoustic model of the masculine singing voice, which is pre-assigned to the key area 1, and the second range spectrum information 511 corresponds to the spectrum inferred from the acoustic model of the feminine singing voice, which is pre-assigned to the key area 2. The key areas 1 and 2 are arranged on both sides of the key area 3. The formant interpolation processing unit 506 then calculates the interpolation spectrum information by the interpolation processing between the first region spectrum information 510 and the second region spectrum information 511, and outputs the interpolated spectrum information as the morphed target spectrum information 513 to the synthesis filter unit 505 in the vocal model unit 503.

This target spectrum information 513 may be referred to as morphing data (third voice data), third spectrum information, or the like.

As a result of the above processing, the synthesis filter unit 505 can output the filter output data 515 as the singing voice output data 417 that is synthesized according to the target spectrum information 513, which is based on the acoustic models as a result of machine-learning the singing voices, with respect to the key area that is well matched to the sound range of the music, as a whole.

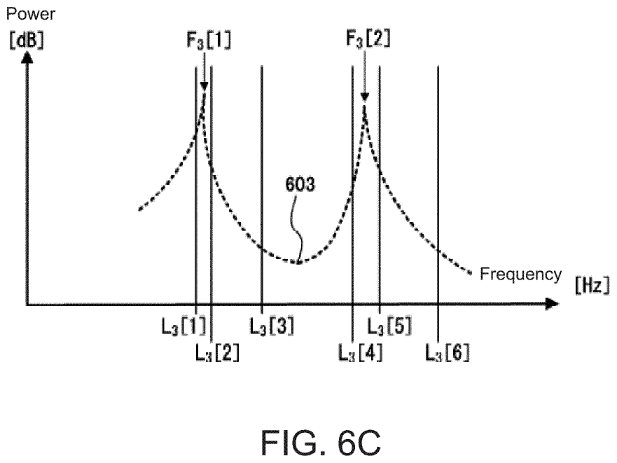

FIGS. 6A-6C are operation explanatory diagrams of the formant interpolation processing unit 506. In each graph shown in FIGS. 6A-6C, the horizontal axis is frequency (Hz) and the vertical axis is power (dB).

The line 601 of FIG. 6A is a graph schematically showing the vocal tract spectral characteristics of a certain voiced phoneme, for example, of the masculine voice in the key area 1 shown in FIG. 1. The vocal tract spectrum characteristic 601 of the key area 1 can be formed by an LSP digital filter formed based on the LSP parameters L₁ [i] (1≤i≤N, N is the LSP analysis order) calculated by the LSP analysis. In FIGS. 6A-6C, for the sake of simplicity of explanation, the LSP analysis order N=6 is shown, but in reality, N=10, for example. In the vocal tract spectrum characteristic 601, F₁ [1] is the first formant frequency of the key area 1, and F₁ [2] is the second formant frequency of the key area 1. The formant frequency is a frequency that forms a pole in the vocal tract spectral characteristics, and determines the difference in voiced phonemes, such as “a”, “i”, “u”, “e”, and “o” that are pronounced through the human vocal tract as well as the difference in female and male voice qualities. Although there are actually higher-order formant frequencies, for the sake of simplicity, the third-order and higher-order formant frequencies are omitted here. The mutual frequency spacings of the LSP parameter L₁ [i] allow good modeling of the spectral characteristics of the human vocal tract; especially the extreme sharpness at the formant frequency (narrowness of the frequency spacing at the foot of the peak), and the strength (power) can be expressed by the frequency spacing of adjacent LSP parameters L₁ [i].

If the music as a whole belongs to, for example, the key area 1 on the bass side of FIG. 1, the acoustic model unit 501 infers the spectrum from the acoustic model of, for example, a masculine singing voice that is pre-assigned to the key area 1. The LSP parameters L₁ [i] (1≤I≤N) corresponding to this spectrum are output as the first range spectrum information 510. Then, the formant interpolation processing unit 506 provides the LSP parameters of the first range spectrum information 510 output from the acoustic model unit 501, as it is, as the LSP parameters of the target spectrum information 513, to the synthesis filter unit 505 in the vocalization model unit 503.

The line 602 of FIG. 6B is a graph schematically showing the vocal tract spectral characteristics of, for example, a feminine voice of the key area 2 exemplified in FIG. 1 for the same voiced phoneme as that of FIG. 6A. The vocal tract spectral characteristic 602 of the key area 2 can be realized by an LSP digital filter formed by the LSP parameters L₂ [i] (1≤i≤N, N is the LSP analysis order) calculated based on the LSP analysis. In the vocal tract spectrum characteristic 602, F₂ [1] is the first formant frequency of the key area 2, and F₂ [2] is the second formant frequency of the key area 2. The other notations in FIG. 6B are the same as those in FIG. 6A.

If the music as a whole belongs to, for example, the key area 2 on the treble side of FIG. 1, the acoustic model unit 501 infers the spectrum from the acoustic model of, for example, a feminine singing voice that is pre-assigned to the key area 2. The LSP parameters L₂ [i] (1≤I≤N) corresponding to the spectrum are output as the second range spectrum information 511. Then, the formant interpolation processing unit 506 provides the LSP parameters of the second range spectrum information 511 output from the acoustic model unit 501, as it is, as the LSP parameters of the target spectrum information 513, to the synthesis filter unit 505 in the vocalization model unit 503.

As can be seen by comparing FIGS. 6A and 6B, the difference between the masculine voice in the key area 1 of FIG. 1 and the feminine voice in the key area 2 of FIG. 1 is the difference in the pitch frequency (female is about twice that of male) in the target sound source information 512 of FIG. 5. Regarding the formant frequencies, it is also known that the first formant frequency F₂ [1] and the second formant frequency F₂ [2] of the feminine voice in the key area 2 are higher than the corresponding first formant frequency F₁ [1] and second formant frequency F₁ [2] of the masculine voice in the key area 1, respectively. See the following document.

Kasuya et. al., “Changes in Pitch and first Three Formant Frequencies of Five Japanese Vowels with Age and Sex of Speakers,”, Journal of the Acoustic Society 24, 6 (1968)

Here, for the sake of clarity, the vocal tract spectral characteristics 601 in FIG. 6A and the vocal tract spectral characteristics 602 in FIG. 6B for the same voiced phoneme are drawn with a slight exaggeration of the differences in formant frequencies.

The line 603 of FIG. 6C is a graph schematically showing the vocal tract spectral characteristics of, for example, a voice between men and women in the key area 3 shown in FIG. 1 for the same voiced phoneme as in FIGS. 6A and 6B. The first formant frequency F₃ [1] in the vocal tract spectral characteristic 603 of the key area 3 is located in the middle of the first formant frequency F₁ [1] of the masculine voice of the key area 1 and the first formant frequency F₂ [1] of the feminine voice of the key area 2. Similarly, the second formant frequency F₃ [2] in the vocal tract spectral characteristic 603 of the key area 3 is located in the middle of the second formant frequency F₁ [2] of the masculine voice of the key area 1 and the second formant frequency F₁ [2] of the feminine voice of the key area 2.

This shows that the vocal tract spectrum characteristic 603 of the singing voice between men and women in the key area 3 can be calculated by a frequency range interpolation processing from the vocal tract spectrum characteristic 601 of the masculine voice in the key area 1 and the vocal tract spectrum characteristic 602 of the feminine voice in the key area 2.

Because the above-mentioned LSP parameters have a frequency dimension, interpolation in frequency range is known to work well. Therefore, in the second embodiment, when the music as a whole belongs to the key area 3 in the middle of FIG. 1, for example, as described above, the acoustic model unit 501 outputs the first range spectrum information 510 corresponding to the spectrum inferred from the acoustic model of the masculine singing voice, which is pre-assigned to the key area 1, as well as the second range spectrum information 511 corresponding to the spectrum inferred from the acoustic model of the feminine singing voice, which is pre-assigned to the key area 2.

Then, the formant interpolation processing unit 506 applies the following equation (1) between the LSP parameter L₁ [i] of the first range spectrum information 510 and the LSP parameter L₂ [i] of the second range spectrum information 511. By executing the operation of the indicated interpolation process, the LSP parameter L₃ [i] of the key area 3 which is the interpolation spectrum information is calculated. Here, N is the LSP analysis order.

L₃[i]=(L₁[i]+L₂[i])/2(1≤i≤N) (1)

The formant interpolation processing unit 506 of FIG. 5 provides the LSP parameters L₃ [i] (1≤i≤N) calculated by the calculation of the above equation (1) to the synthesis filter unit 505 of the vocalization model unit 503 as the target spectrum information 513 of FIG. 5.

As a result of the above processing, the synthesis filter unit 505 can output the filter output data 515, as the singing voice output data 417, that is synthesized by the target spectrum information 513 having the optimum vocal tract spectral characteristics that well matches the sound range of the entire music.

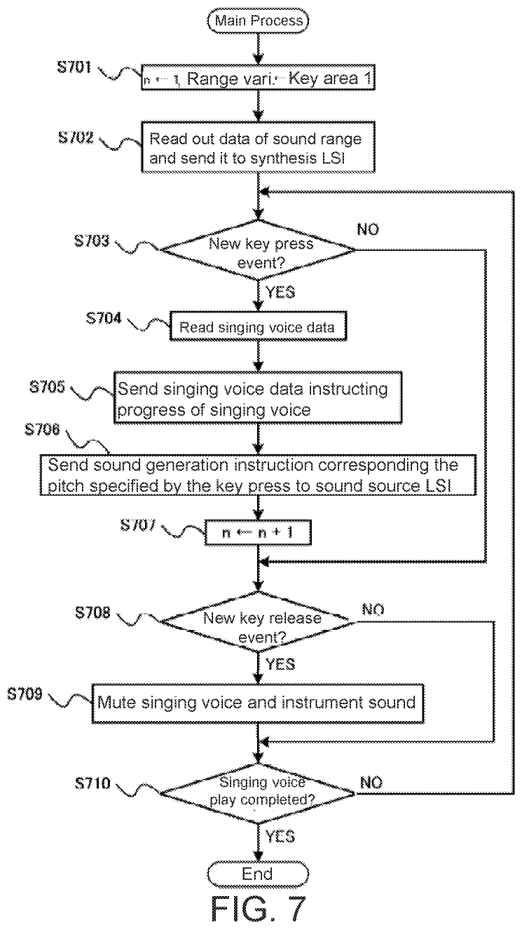

The detailed operation of the second embodiment having the configuration of FIGS. 3 to 5 will be described below. FIG. 7 is a flowchart showing an example of the main process of singing voice synthesis in the second embodiment. This is a process executed by the CPU 401 of FIG. 4 by loading a singing voice synthesis program stored in the ROM 402 into the RAM 403.

First, the CPU 401 assigns the initial value “1” to the lyrics index variable n, which is a variable on the RAM 403 indicating the current position of the lyrics, and assigns, to a range setting variable, which is a variable on the RAM 403 indicating a currently set or default sound range, an initial value that indicates that the current sound range is the key area 1, for example, in FIG. 1 (step S701). When the lyrics are started from the middle (for example, starting from the previously stored position), a value other than “0” may be assigned to the lyrics index variable n.

The lyrics index variable n may be a variable indicating the position of a syllable (or character(s)) as counted from the beginning when the entire lyrics are regarded as a character string. For example, the lyrics index variable n can indicate the singing voice data at the nth playback position of the singing voice data 415 shown in FIG. 5. In the present disclosure, the lyrics corresponding to the position of one lyrics (a specific lyrics index variable n) may correspond to one or a plurality of characters constituting one syllable. The syllables included in the singing voice data may include various syllables such as vowels only, consonants only, and consonants plus vowels.

Next, before the start of singing voice synthesis, the CPU 401 reads out key area data indicating which one of the key areas 1, 2, and 3 of FIG. 1 the entire song for singing voice synthesis to be performed belongs to on average, and includes the key area data in the singing voice data 415. Then, the CPU 401 transmits the resulting singing voice data 415 to the voice synthesis LSI 405 of FIG. 4 (step S702).

After that, the CPU 401 advances the singing voice synthesis process by repeatedly executing the series of processes from steps S703 to S710 while incrementing the value of the lyrics index variable n by +1 in step S707 until it determines that playing the singing voice data is completed (there is no singing voice data corresponding to the new value of the lyrics index variable n) in step S710.

In a series of iterative processes from steps S703 to S710, the CPU 401 first determines whether or not there is a new key pressed as a result of the key scanner 406 of FIG. 4 scanning the keyboard 301 of FIG. 3 (step S703).

If the determination in step S703 is YES, the CPU 401 reads the singing voice data of the nth lyrics indicated by the value of the lyrics index variable n on the RAM 403 from the RAM 403 (step S704).

Next, the CPU 401 transmits the singing voice data 415 instructing the progress of the singing voice including the singing voice data read in step S704 to the voice synthesis LSI 405 (step S705).

Further, the CPU 401 transmits sound generation instructions, as the sound generation control data 416, which specify a pitch corresponding to the key pressed by the performer of any of the keyboard 301 detected by the key scanner 406 as well as the musical instrument sound previously designated by the performer on the switch panel 303 of FIG. 3, to the sound source LSI 404 (step S706).

As a result, the sound source LSI 404 generates the music sound output data 418 corresponding to the sound generation control data 416. The music sound output data 418 is converted into an analog music sound output signal by the D/A converter 411. This analog music sound output signal is mixed with the analog singing voice output signal output from the voice synthesis LSI 405 via the D/A converter 412 by the mixer 413, and the mixed signal is amplified by the amplifier 414, and then output from a speaker or output terminal.

Note that the process of step S706 may be omitted. In this case, the performer does not produce a musical tone in response to the key press operation, and the key press operation is used only for the progress of singing voice synthesis.

Then, the CPU 401 increments the value of the lyrics index variable n by +1 (step S707).

After the process of step S707 or after the determination of step S703 becomes NO, the CPU 401 determines whether or not there is a new key release as a result of the key scanner 406 of FIG. 4 scanning the keyboard 301 of FIG. 3 (step S708).

If the determination in step S708 is YES, the CPU 401 instructs the voice synthesis LSI 405 to mute the singing voice corresponding to the pitch of the key release detected by the key scanner 406, and the sound source LSI 404 to mute the musical sound corresponding to the pitch (step S709). As a result, the corresponding muting operations are executed in the voice synthesis LSI 405 and the sound source LSI 404.

After the processing of step S709, or when the determination in step S708 is NO, the CPU 401 determines whether there is no singing voice data corresponding to the value of the lyrics index variable n incremented in step S707 on the RAM 403, and the playback of the singing voice data should therefore end (step S710).

If the determination in step S710 is NO, the CPU 401 returns to the process of step S703 and proceeds with the process of singing voice synthesis.

When the determination in step S710 becomes YES, the CPU 401 ends the process of singing voice synthesis exemplified in the flowchart of FIG. 7.

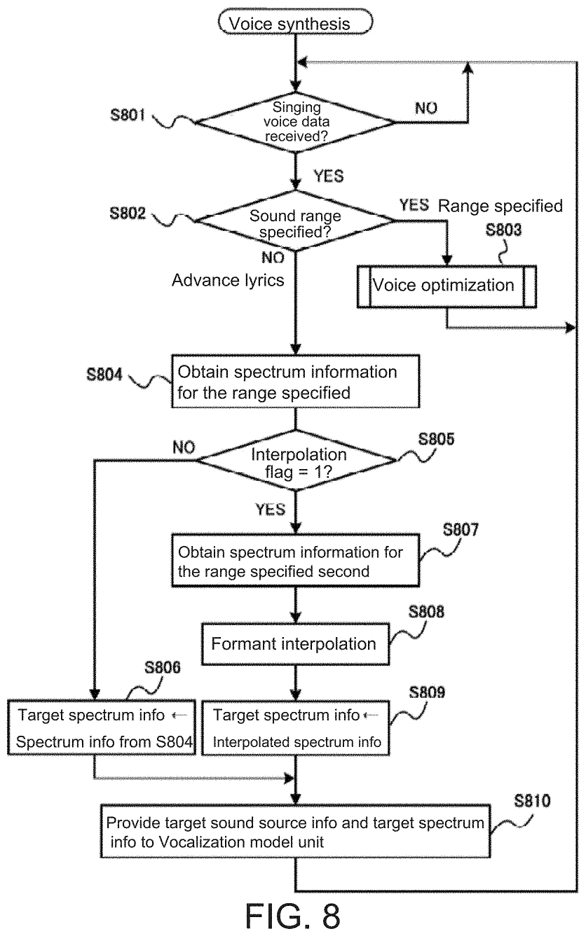

FIG. 8 is a flowchart showing an example of the voice synthesis process executed by a processor in the voice synthesis LSI 405 of FIG. 4 in the second embodiment. This may be a process in which the processor executes a voice synthesis processing program stored in a memory in the voice synthesis LSI 405. Alternatively, this processing may be a hybrid processing by hardware and software by DSP (digital signal processor) or FPGA (field programmable gate array) or the like.

The processor of the voice synthesis LSI 405 realizes the respective functions of various parts shown in FIG. 5 by executing the voice synthesis processing program, for example. The following description of each process is actually executed by the processor, but will be described as a process executed by the corresponding part or unit of FIG. 5 for the ease of explanation. Thus, as mentioned above, in this disclosure, the term “unit”, “process”, “section” may be interchangeably used to indicate the corresponding functionality, as the case may be, and each such feature may be realized by appropriate computer program, subroutine or function of program, and/or hardware and any combinations thereof.

First, the text analysis unit 502 of FIG. 5 is in a standby state of repeating the process of determining whether or not the singing voice data 415 has been received from the CPU 401 of FIG. 4 (the determination process of step S801 is repeated NO).

When the singing voice data 415 is received from the CPU 401 and the determination in step S801 is YES, the text analysis unit 502 determines whether or not the sound range is specified by the received singing voice data 415 (see step S702 in FIG. 7) (step S802).

If the determination in step S802 is YES, the range information 509 is passed from the text analysis unit 502 to the formant interpolation processing unit 506. After that, the formant interpolation processing unit 506 perform subsequent steps.

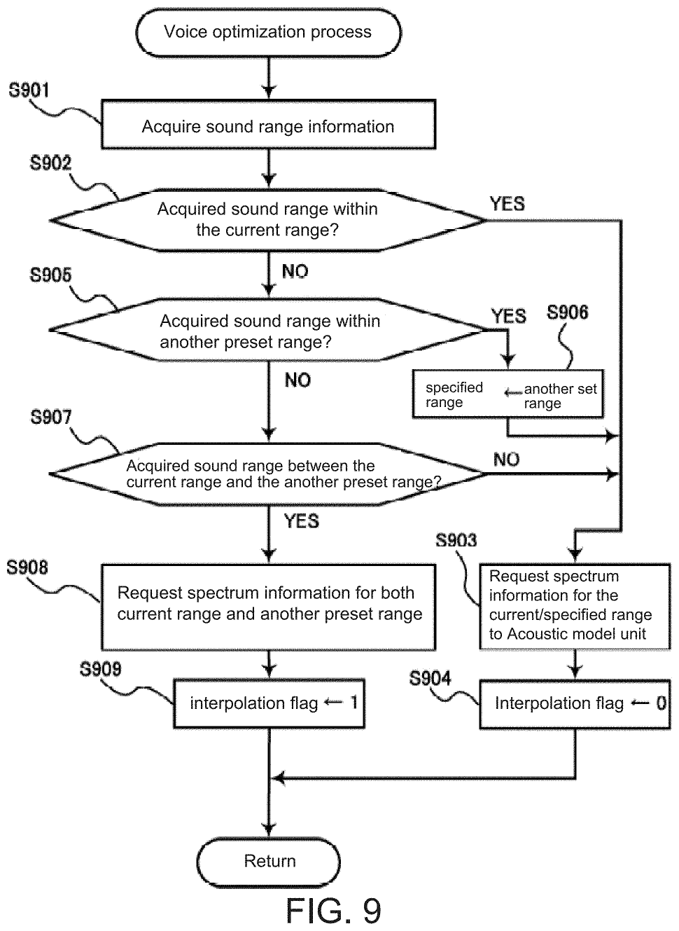

The formant interpolation processing unit 506 executes the singing voice optimization processing (step S803). The details of this process will be described later using the flowchart of FIG. 9. After the singing voice optimization process of step S803, the process returns to the standby process of the singing voice data 415 of step S801 by the text analysis unit 502.

After the singing voice data 415 is received again and the determination in step S801 is YES, if the determination in step S802 is NO in the text analysis unit 502, the received singing voice data 415 is instructing the advancement of the lyrics. (See step S705 in FIG. 7). The text analysis unit 502 therefore analyzes the lyrics and the pitch included in the singing voice data 415. As a result, the text analysis unit 502 generates the linguistic feature sequence 507 expressing the phonemes, parts, words, etc., corresponding to the lyrics in the singing voice data 415, and the pitch information 508 corresponding to the pitch in the singing voice data 415, and forward them to the acoustic model unit 501.

On the other hand, by the singing voice optimization processing of step S803 executed before the start of singing voice synthesis, the formant interpolation processing unit 506 has requested the acoustic model unit 501 for the first or second range spectrum information 510 or 511 or both first range spectrum information 510 and second range spectrum information 511.

Based on each of the above information pieces, the formant interpolation processing unit 506 acquires the respective LSP parameters of the spectrum information that has been requested to the acoustic model unit 501 in step S903 or S908 (in the case of S908, the spectrum information requested first) of FIG. 9 in the singing voice optimization process of step S803, which will be described later, and stores them in the RAM 403 (step S804).

Next, the formant interpolation processing unit 506 determines whether or not the value “1” is set in the interpolation flag stored in the RAM 403 in the singing voice optimization process (step S803), which will be described later, that is, whether or not the interpolation process should be executed (step S805).

If the determination in step S805 is NO (no interpolation processing should be executed), the formant interpolation processing unit 506 acquires respective LSP parameters of the spectrum information (510 or 511) that has been acquired from the acoustic model unit 501 and stored in the RAM 403 in step S804, and set them in the array variables for the target spectrum information 513 on the RAM 403, as it is (step S806).

If the determination in step S805 is YES (execute interpolation processing), the formant interpolation processing unit 506 acquires respective LSP parameters of the spectrum information that has been secondly requested to the acoustic model unit 501 in step S908 of FIG. 9 in the singing voice optimization process of step S803, which will be described later, and stores them in the RAM 403 (step S807).

Then, the formant interpolation processing unit 506 executes the formant interpolation processing (step S808). Specifically, the formant interpolation processing unit 506 calculates the LSP parameters L₃ [i] of interpolated spectrum information from the LSP parameters L₁ [i] of the spectrum information that has been stored in the RAM 403 in step S804 and the LSP parameters L₂ [i] of the spectrum information that has been stored in the RAM 403 in step S807 by executing an interpolation processing operation of, for example, the above-mentioned equation (1), and store them in the RAM 403.

After step S808, the formant interpolation processing unit 506 sets LSP parameters L₃ [i] of the interpolated spectrum information that have been stored in the RAM 403 in step S808 to the array variables for the target spectrum information 513 on the RAM 403 (step S809).

After step S806 or S809, the target sound source information 512 output from the acoustic model unit 501 is provided to the sound source generation unit 504 of the vocalization model unit 503. At the same time, the formant interpolation processing unit 506 sets the respective LSP parameters of the target spectrum information 513 stored in the RAM 403 in step S806 or S809 to the LSP digital filter of the synthesis filter unit 505 in the vocalization model unit 503 (S810). After that, the CPU 401 returns to the standby process of waiting for the singing voice data 415 in step S801, which is executed by the text analysis unit 502.

As a result of the above processing, the vocalization model unit 503 outputs the filter output data 515 as the singing voice output data 417 by exciting the LSP digital filter of the synthesis filter unit 505 in which the target spectrum information 513 has been set through the sound source input data 514 from the sound source generation unit 504 in which the target sound source information 512 has been set.

FIG. 9 is a flowchart showing a detailed example of the singing voice optimization process of step S803 of FIG. 8. This processing is executed by the formant interpolation processing unit 506 of FIG. 5.

First, the formant interpolation processing unit 506 acquires the information of the range (key range) set in the range information 509 handed over from the text analysis unit 502 (step S901).

Next, the formant interpolation processing unit 506 determines whether the sound range of the entire music that is set in the singing voice data 415 acquired in step S901 (see the description of step S702) is within the default sound range (current sound range) set by the range setting variable stored in the RAM 403 (step S902).

Here, the key area 1 in FIG. 1, for example, is initially set in the range setting variable (see step S701 in FIG. 7).

If the determination in step S902 is YES, the formant interpolation processing unit 506 requests the acoustic model unit 501 for the spectrum information corresponding to the sound range that is currently set in the range setting variable (step S903).

After that, the formant interpolation processing unit 506 sets the value “0” indicating that the interpolation processing will not be needed in the interpolation flag variable on the RAM 403 (step S904). In this case, when this interpolation flag variable is referred to in step S805 of FIG. 8 illustrating the above-mentioned voice synthesis processing, the determination in step S805 becomes NO, and the interpolation processing will not be executed. Then, the formant interpolation processing unit 506 ends the singing voice optimization process of step S803 of FIG. 8 shown in the flowchart of FIG. 9.

If the range of the entire song set in the singing voice data 415 acquired in step S901 is not within the range of the default/currently set range and the determination in step S902 is NO, the formant interpolation processing unit 506 determines whether or not the range of the entire song is within another preset range other than the default/current range (for example, the key range 2 in FIG. 1) (step S905).

If the determination in step S905 is YES, the formant interpolation processing unit 506 replaces the value of the range setting variable indicating the current/default range on the RAM 403 with the value indicating the another preset range (step S906).

Then, the formant interpolation processing unit 506 requests the acoustic model unit 501 for the spectrum information corresponding to the updated range that is set in the range setting variable (step S903), and sets the value of the interpolation flag variable on the RAM 403 to 0 (step S904). Thereafter, the formant interpolation processing unit 506 ends the singing voice optimization process of step S803 of FIG. 8 shown in the flowchart of FIG. 9.

If the entire range of the music set in the singing voice data 415 acquired in step S901 is not within the range of the default/current range (determination of step S902 is NO), and also is not within the another preset range other than the default/current range (step S905 is also NO), then the formant interpolation processing unit 506 determines whether or not the range of the entire music is between the default/current range indicated by the current range setting variable and the another preset range (step S907).

If the determination in step S907 is YES, the formant interpolation processing unit 506 requests the acoustic model unit 501 for the spectrum information corresponding to the default/current range set in the range setting variable as well as the spectrum information corresponding to the another preset range determined in step S907 (step S908).

After that, the formant interpolation processing unit 506 sets the value “1” indicating that the interpolation processing should be executed in the interpolation flag variable on the RAM 403 (step S909). When this interpolation flag variable is referred to in step S805 of FIG. 8 illustrating the above-mentioned voice synthesis processing, the determination in step S805 becomes YES, and the interpolation processing is executed in step S808. After that, the formant interpolation processing unit 506 ends the singing voice optimization process of step S803 of FIG. 8 shown in the flowchart of FIG. 9.

If the determination in step S907 is NO, the formant interpolation processing unit 506 cannot determine the range. At this time, the formant interpolation processing unit 506 maintains the currently set range and requests the acoustic model unit 501 for the spectrum information corresponding to the default/current range set in the range setting variable (step S903), and set the value “0” in the interpolation flag variable on RAM 403 (step S904). After that, the formant interpolation processing unit 506 ends the singing voice optimization process of step S803 of FIG. 8 shown in the flowchart of FIG. 9.

In the second embodiment described above, the singing voice data 415 specifying the range was transmitted to the voice synthesis LSI 405 of FIG. 4 before the start of the singing voice synthesis, and in the voice synthesis LSI 405, before the start of the singing voice synthesis, the formant interpolation processing unit 506 performed the singing voice optimization process based on the singing voice data 415 that specified the above-mentioned sound range received via the text analysis unit 502 so as to control the sound range requested to the acoustic model unit 501. Alternatively, the formant interpolation processing unit 506 of the voice synthesis LSI 405 may control the range of the singing voice based on the pitch included in each of the singing voice data 415 for each singing voice to be produced. By this processing, for example, even when the range of the music to be synthesized by singing voice extends over a wide range of the key areas 1, 2, and 3 in FIG. 1, an appropriate acoustic model(s) can be selected and applied based on the singing voice data 415 at the time of the production for the vocalization model unit 503 to process.

Further, in the singing voice optimization process exemplified in the flowchart of FIG. 9 executed by the formant interpolation processing unit 506 in the second embodiment described above, a series of determination processes for determining which range the range given as the range information 509 belongs to (steps S902, S905, S907, etc., in FIG. 9) was required. Alternatively, a table can be prepared and stored in ROM 402 or the like in FIG. 4 for indicating that, with respect to each of sound ranges (for example, key areas 1, 2, and 3 in FIG. 1), key area 1 alone is sufficient (if it is in the key area 1), key area 2 alone is sufficient (if it is in the key area 2), or interpolation between the key areas 1 and 2 is required (if it is between key areas 1 and 2). In this case, the formant interpolation processing unit 506 may execute the singing voice optimization processing by referring to the table. Even if the key range setting and the interpolation setting are very complex, the selection of the range and the determination of the presence/absence of the interpolation process can be always appropriately performed by referring to such a table.

Further, in the second embodiment described above, in the vocalization model unit 503, the sound source input data 514 that excites the synthesis filter unit 505 was generated by the sound source generation unit 504 of FIG. 5 based on the target sound source information 512 from the acoustic model unit 501. In the alternative, the sound source input data 514 for the vocal sound source may not be generated by the sound source generation unit 504, but may be a part of the music sound output data 418 generated by the sound source LSI 404 in FIG. 4 using a specific sound source channel(s). With such a configuration, it is possible to generate the singing voice output data 417, which retains the characteristics of a specific musical tone generated by the sound source LSI 404 in an interesting manner.

In the second embodiment described above, the acoustic models set in the acoustic model unit 501 are obtained by machine-learning with training music score data that include training lyrics information, training pitch information, and training sound range information, and training signing voice data of singers. Here, as the acoustic models, models using a general phoneme database may be adopted instead.

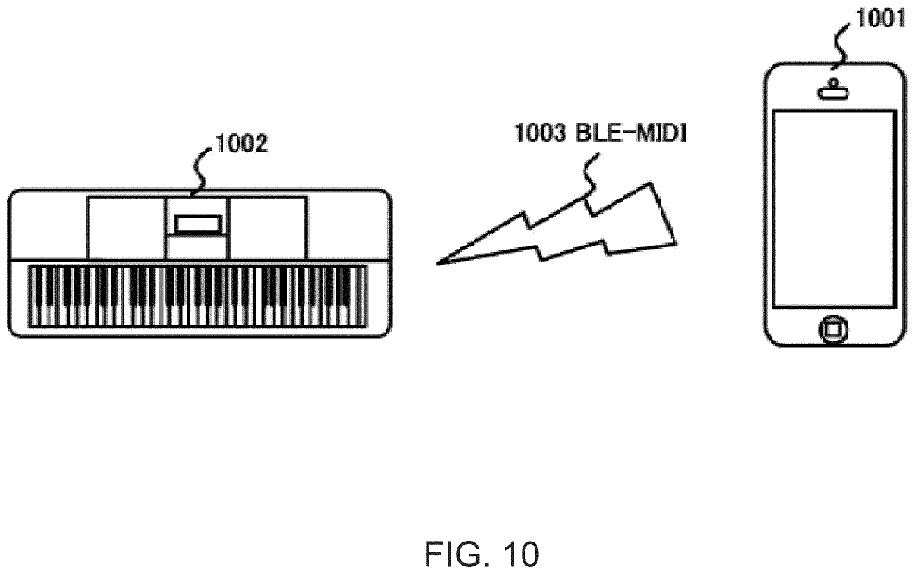

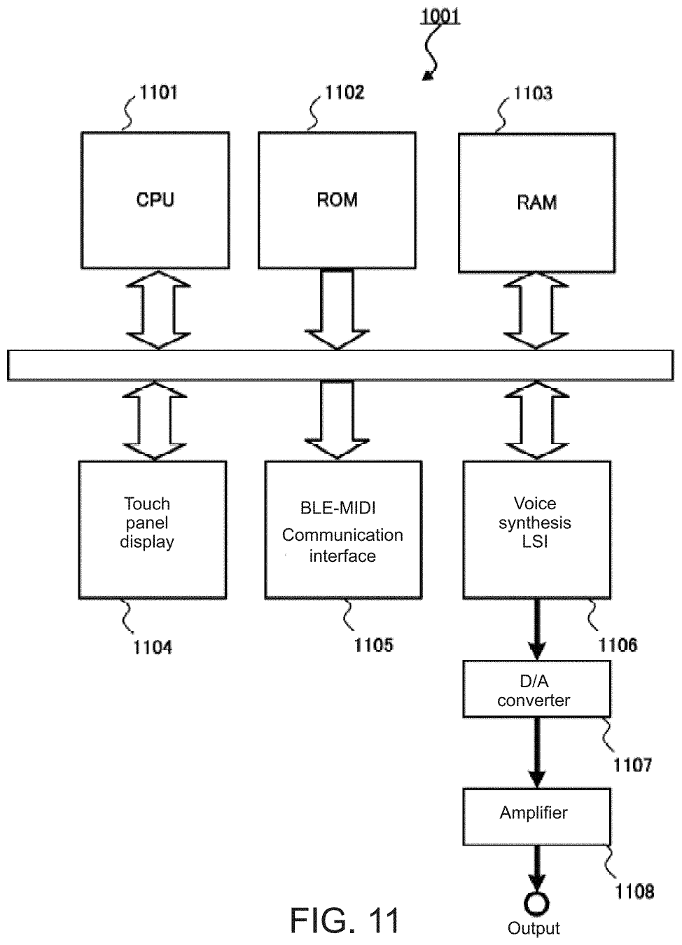

In the second embodiment described above, the voice synthesis LSI 405, which is the information processing device according to one aspect of the present invention and the voice synthesis unit 500, which is one of the functions of the information processing device, respectively shown in FIGS. 4 and 5, are built into the control system 400 of the electronic keyboard instrument 300. In another form, the voice synthesis LSI and the voice synthesis unit which is one of the functions of the voice synthesis LSI (hereinafter collectively referred to as “voice synthesis part”) may be separate from the electronic musical instrument. FIGS. 10 and 11 are diagrams showing a third embodiment in which the voice synthesis part and the electronic keyboard instrument operate separately, and show a connection form example of the voice synthesis part and the electronic keyboard instrument and a hardware configuration example of the voice synthesis part, respectively.

As shown in FIG. 10, in the third embodiment, the voice synthesis LSI 405, which is shown in FIG. 4 in the second embodiment, and the voice synthesis unit 500 shown in FIG. 5, which is one of the functions of the voice synthesis LSI 405, are implemented as dedicated hardware and/or software (app) in a tablet terminal or a smart phone (hereinafter referred to as “tablet terminal or the like”) 1001, for example, and the electronic musical instrument is configured as an electronic keyboard instrument 1002 having no voice synthesis function, for example.

FIG. 11 is a diagram showing a hardware configuration example of the tablet terminal or the like 1001 in the third embodiment having the connection form shown in FIG. 10. In FIG. 11, the CPU 1101, ROM 1102, RAM 1103, voice synthesis LSI 1106, D/A converter 1107, and amplifier 1108 have the same or similar functionalities as the CPU 401, ROM 402, RAM 403, voice synthesis LSI 405, D/A converter 412, and amplifier 414 of FIG. 4. The output of the amplifier 1108 is connected to a speaker or earphone terminal in the tablet terminal or the like 1001. The functions of a part of the switch panels 302 and 303 of FIG. 3 are provided by the touch panel display 1104.

In the third embodiment having the configuration examples of FIGS. 10 and 11, the tablet terminal or the like 1001 and the electronic keyboard instrument 1002 are wirelessly communicated with each other based on a standard called “MIDI over Bluetooth Low Energy” (hereinafter referred to as “BLE-MIDI”). BLE-MIDI is a wireless communication standard between musical instruments that enables communication with MIDI (Musical Instrument Digital Interface), which is a standard for communication between musical instruments, on the wireless standard Bluetooth Low Energy (registered trademark). The electronic keyboard instrument 1002 can be connected to the BLE-MIDI communication interface 1105 (FIG. 11) of the tablet terminal or the like 1001 according to the Bluetooth Low Energy standard. In that state, the key press information and key release information including the pitch information specified by playing the electronic keyboard instrument 1002 are notified in real time, via BLE-MIDI, to the singing voice synthesis app executed on the tablet terminal or the like 1001.

Instead of the BLE-MIDI communication interface 1105, a MIDI communication interface connected to the electronic keyboard instrument 1002 with a wired MIDI cable may be used.

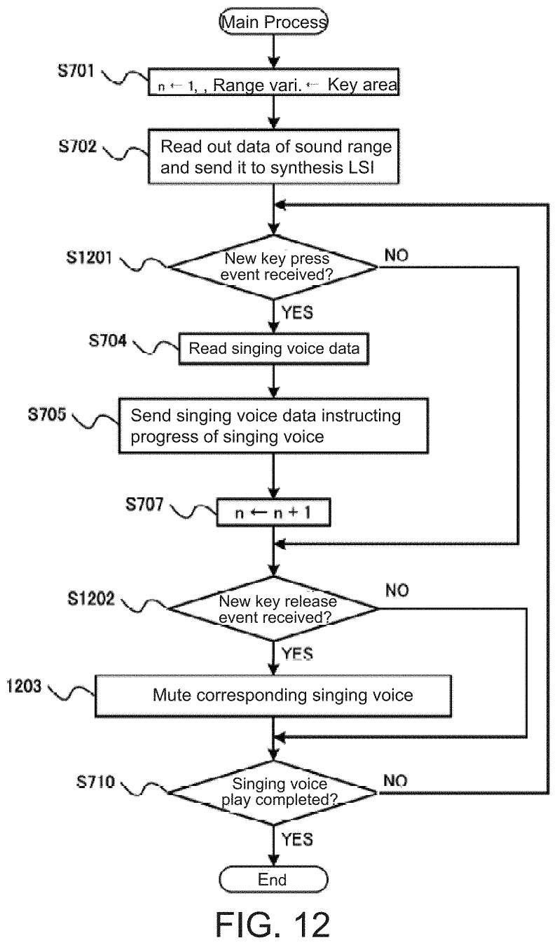

In the third embodiment, the electronic keyboard instrument 1002 of FIG. 10 does not have a voice synthesis LSI built-in, and the tablet terminal or the like 1001 has a voice synthesis LSI 1106 (FIG. 11) built-in. Then, in FIG. 11, the CPU 1101 of the tablet terminal or the like 1001 executes the main process exemplified by the flowchart of FIG. 12 that is similar to the flowchart illustrated in FIG. 7 of the second embodiment, for example, as the process of the singing voice synthesis app so as to perform control process of singing voice synthesis that is the same as or similar to that described in the flowchart of FIG. 7. In the flowchart illustrated in FIG. 12, the steps assigned the same step numbers as the flowchart illustrated in FIG. 7 perform the same processing as that in FIG. 7. In the flowchart illustrated in FIG. 12, a part of the processing of steps S706 and S709 for the sound source LSI 404 of FIG. 4 in the flowchart of FIG. 7 is omitted.

The CPU 1101 monitors whether or not the key pressing information and the key release information are received from the electronic keyboard instrument 1002 via the BLE-MIDI communication interface 1105.

When the CPU 1101 receives the key press information from the electronic keyboard instrument 1002, the CPU 1101 executes the same processing as in steps S703 and S704 of FIG. 7. That is, when the determination in step S1201 is YES, the CPU 1101 reads the singing voice data of the nth lyrics indicated by the value of the lyrics index variable n on the RAM 1103 from the RAM 1103 (step S704 in FIG. 12).

Then, the CPU 1101 transmits the singing voice data 415 (see FIG. 5) instructing the progress of the singing voice including the singing voice data read in step S704 of FIG. 12 to the voice synthesis LSI 1106 of FIG. 11 built in the tablet terminal or the like 1001 (step S705 in FIG. 12).

On the other hand, when the CPU 1101 receives the key release information from the electronic keyboard instrument 1002, the CPU 1101 executes the same processing as a part of the processing in step S709 of FIG. 7. That is, in FIG. 12, when the determination in step S1202 is YES, the CPU 1101 instructs the voice synthesis LSI 1106 of FIG. 11 that is built in the tablet terminal or the like 1001 to mute the singing voice corresponding to the pitch of the key included in the key release information (step S1203 in FIG. 12).

By repeating the control processing of steps S705 and S1203 of FIG. 12 described above, the voice synthesis LSI 1106 of FIG. 11 in the tablet terminal or the like 1001 executes processes that are the same as or similar to those exemplified by the flowcharts of FIGS. 8 and 9 performed by the voice synthesis unit 500 of FIG. 5 described above in the second embodiment. As a result, for example, in the voice synthesis LSI 1106, singing voice output data equivalent to the singing voice output data 417 in the second embodiment is generated. This singing voice output data is output from the built-in speaker of the tablet terminal or the like 1001, or is transmitted from the tablet terminal or the like 1001 to the electronic keyboard instrument 1002 and output from a built-in speaker of the electronic keyboard instrument 1002 so that the synthesized voice can be output in synchronization with the performer's operations of the keyboard instrument 1002.

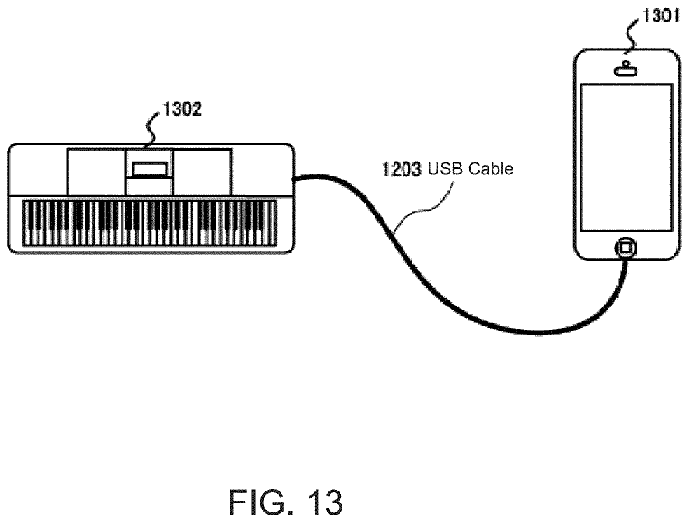

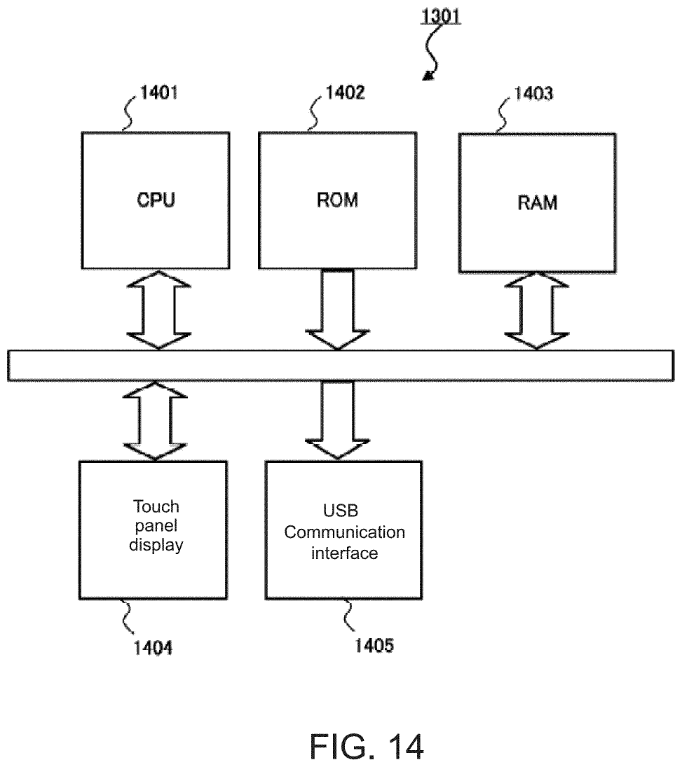

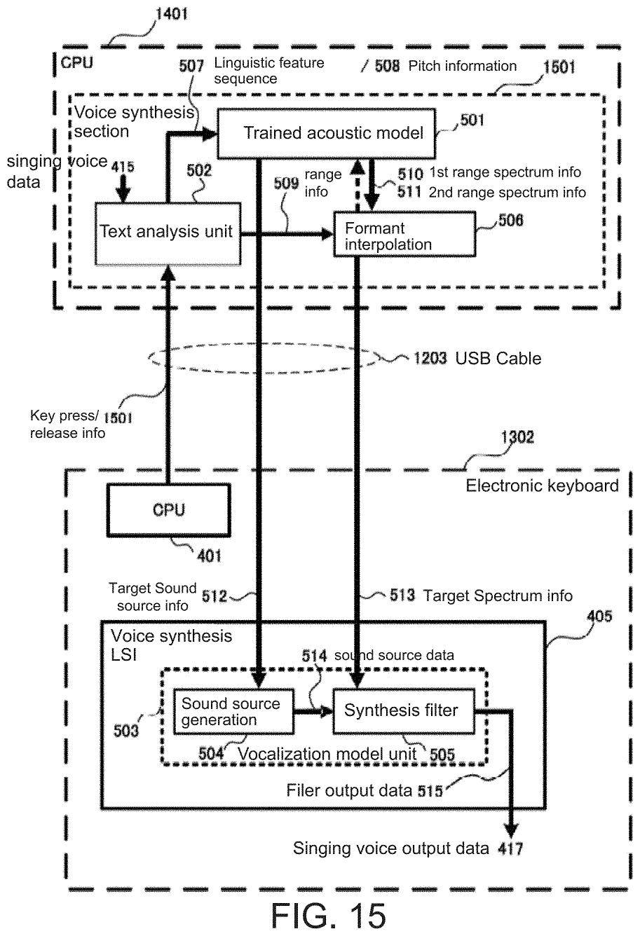

Next, a fourth embodiment will be described. FIG. 13 is a diagram showing a connection form of a fourth embodiment in which a part of the voice synthesis unit and the electronic keyboard instrument operate separately. FIG. 14 shows a hardware configuration example of a tablet terminal or the like 1301 of the fourth embodiment corresponding to the voice synthesis unit. FIG. 15 is a block diagram showing a configuration example of a part of the voice synthesis LSI and the voice synthesis unit in the fourth embodiment.

In the second embodiment having the block configuration of FIG. 5 described above, the voice synthesis unit 500 was implemented as a function of the voice synthesis LSI 405 built in the electronic keyboard instrument including the control system 400 of FIG. 4. On the other hand, in the above-mentioned third embodiment, the voice synthesis unit 500 of FIG. 5 was implemented as a function of the voice synthesis LSI 1106 of FIG. 11 incorporated in the tablet terminal or the like 1001 of FIG. 10. In the third embodiment, the voice synthesis LSI 1106 of FIG. 11 built in the tablet terminal or the like 1001 had the same function as the voice synthesis LSI 405 built in the electronic keyboard instrument including the control system 400 of FIG. 4 in the second embodiment.

In the fourth embodiment, the electronic keyboard instrument 1302 and the tablet terminal or the like 1301 are connected by, for example, a USB cable 1203. In this case, the control system of the electronic keyboard instrument 1302 has a block configuration equivalent to that of the control system 400 of the electronic keyboard instrument 300 in the second embodiment illustrated in FIG. 4, and incorporates a voice synthesis LSI 405. In the fourth embodiment, however, unlike the third embodiment, the tablet terminal or the like 1301 does not have a built-in voice synthesis LSI and may be a general-purpose terminal computer or processor. FIG. 14 is a diagram showing a hardware configuration example of the tablet terminator or the like 1301 of FIG. 13 in the fourth embodiment. In FIG. 14, the CPU 1401, ROM 1402, RAM 1403, and touch panel display 1404 have the same functions as the CPU 1101, ROM 1102, RAM 1103, and touch panel display 1104 of FIG. 11 of the third embodiment. As shown in FIG. 13, the USB (Universal Serial Bus) communication interface 1405 transmits and receives signals to and from the electronic keyboard instrument 1302 using the USB cable 1203 that connects the tablet terminal or the like 1301 and the electronic keyboard instrument 1302. Although not particularly shown, a similar USB communication interface is mounted on the side of the electronic keyboard instrument 1302.

If the data capacity allows, wireless communication interfaces such as Bluetooth (registered trademark of Bluetooth SIG, Inc. in the US) and Wi-Fi (registered trademark of Wi-Fi Alliance in the US) or the like may be used instead of the wired USB communication interface.

In FIG. 15 of the fourth embodiment, the block having the same reference number as the reference number of each block in the block diagram of FIG. 5 has the same function as that of FIG. 5. The vocalization model unit 503 (voice synthesis filter unit) of FIG. 15 according to the fourth embodiment is separated from the voice synthesis unit 1501 and is implemented in the voice synthesis LSI 405 of the control system 400 of FIG. 4, which has the same configuration as that of the second embodiment.

Each functional unit of the acoustic model unit 501, the text analysis unit 502, and the formant interpolation processing unit 506 in the voice synthesis unit 1501 of FIG. 15 according to the fourth embodiment are the same as or similar to corresponding functional unit of the acoustic model unit 501, the text analysis unit 502, and the formant interpolation processing unit 506 in the voice synthesis unit 500 shown in FIG. 5 in the second embodiment.

Specifically, these processes are processes performed by the CPU 1401 of the tablet terminal or the like 1301 of FIG. 14 by reading a voice synthesis program from the ROM 1402 to the RAM 1403. By executing this voice synthesis program, the CPU 1401 executes the same main processing as illustrated in the flowchart of FIG. 12 in the third embodiment. Further, in the fourth embodiment, the CPU 1401 executes the voice synthesis process, which is exemplified by the flowchart of FIG. 8, and the singing voice optimization process, which is exemplified by the flowchart of FIG. 9 and which details step S803 of FIG. 8, both of which were executed by the processors in the voice synthesis LSI 405 in the second embodiment,

However, in step S705 of FIG. 12, the CPU 1401 does not transmit the singing voice data 415 (see FIG. 5) instructing the progress of the singing voice including the singing voice data read in step S704 of FIG. 12 to the voice synthesis LSI. Instead, the CPU 1401 hands over the singing voice data 415 to the voice synthesis process exemplified in the flowchart of FIG. 8.

Then, as shown in FIG. 15, in the voice synthesis process step S810 of the voice synthesis process exemplified by the flowchart of FIG. 8, the CPU 1401 transmits the target spectrum information 513, which was generated in step S806 or S809 of FIG. 8, and the target sound source information 512, which is output from the acoustic model unit 501, to the vocalization model unit 503 implemented by the voice synthesis LSI 405 (FIG. 4) in the electronic keyboard instrument 1302, from the USB communication interface 1405 of FIG. 14 via the USB cable 1203 of FIG. 13.

As a result, the singing voice output data 417 is generated in the voice synthesis LSI 405 (FIG. 4) in the electronic keyboard instrument 1302. The singing voice output data 417 is converted into an analog singing voice output signal by the D/A converter 412 in FIG. 4 similar to the second embodiment. This analog singing voice audio output signal is mixed with the analog music output signal by the mixer 413, amplified by the amplifier 414, and is output from a speaker or an output terminal.

As described above, in the fourth embodiment, the function of the voice synthesis LSI 405 of the electronic keyboard instrument 1302 and the function of the singing voice synthesis of the tablet terminal or the like 1301 are combined to enable production of synthesized voice in synchronization with the performer's operation on the electronic keyboard instrument 1302.

Here, the acoustic model unit 501 including the trained models may be built in the information processing device side such as a tablet terminal 1301 or a server device, and certain data generation parts, such as the formant interpolation processing unit 506, may be installed in the instrument side, such as in the electronic keyboard instrument 1302. In this case, the information processing device transmits the first range spectrum information 510 and/or the second range spectrum information 511 to the electronic keyboard instrument 1302 for processing, such as formant interpolation processing.

Although the embodiments of the disclosure and their advantages have been described in detail above, those skilled in the art can make various changes, additions, and omissions without departing from the scope of the present invention as set forth in the claims.

In addition, the present invention is not limited to the above-described embodiments, and can be variously modified at the implementation stage without departing from the gist thereof. In addition, the functions executed in the above-described embodiments may be combined as appropriate as possible. The embodiments described above include various stages, and various inventions can be extracted by an appropriate combination according to a plurality of disclosed constituent requirements. For example, even if some constituent elements are deleted from all the constituent elements shown in the embodiment, if the same or similar effect is obtained, the configuration in which the constituent elements are deleted can be extracted as an

Further, it will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. An information processing device for voice synthesis, comprising:
at least one processor, implementing a first voice model and a second voice model different from the first voice model, the at least one processor performing the following:
receiving data indicating a specified pitch; and
causing the first voice model to output a first data and the second voice model to output a second data, and generating and outputting a third data corresponding to the specified pitch based on the first data and second data.

2. The information processing device according to claim 1,
wherein the first voice model includes a trained model that has been trained with a singing voice of a first singer,
wherein the second voice model includes a trained model that has trained with a singing voice of a second singer different from the first singer.

3. The information processing device according to claim 1,
wherein the at least one processor generates the third data by an interpolation calculation between formant frequencies corresponding to the first data and formant frequencies corresponding to the second data.

4. The information processing device according to claim 1,
wherein the at least one processor further receives information on a music piece to be played, and when the information on the music piece indicates that a sound range of the music piece does not correspond to a sound range of the first voice model or a sound range of the second voice model, the at least one processor generates the third data.

5. The information processing apparatus according to claim 1,
wherein the first voice model has a first sound range, and the second voice model has a second sound range different from and not overlapping with the first sound range so that there is a non-overlapping sound range between the first and second sound ranges, and
wherein the at least one processor generates the third data when the specified pitch belongs to the non-overlapping range.

6. An electronic musical instrument, comprising:
a performance unit for specifying a pitch; and
the information processing device including the at least one processor, as set forth in claim 1, the at least one processor receiving the data indicating the specified pitch from the performance unit.

7. The electronic musical instrument according to claim 6,
wherein the first voice model includes a trained model that has been trained with a singing voice of a first singer,
wherein the second voice model includes a trained model that has trained with a singing voice of a second singer different from the first singer.

8. The electronic musical instrument according to claim 6,
wherein the at least one processor generates the third data by an interpolation calculation between formant frequencies corresponding to the first data and formant frequencies corresponding to the second data.

9. The electronic musical instrument according to claim 6,
wherein the at least one processor further receives information on a music piece to be played, and when the information on the music piece indicates that a sound range of the music piece does not correspond to a sound range of the first voice model or a sound range of the second voice model, the at least one processor generates the third data.

10. The electronic musical instrument according to claim 6,
wherein the first voice model has a first sound range, and the second voice model has a second sound range different from and not overlapping with the first sound range so that there is a non-overlapping sound range between the first and second sound ranges, and
wherein the at least one processor generates the third data when the specified pitch belongs to the non-overlapping range.

11. An electronic musical instrument, comprising:
a performance unit for specifying a pitch;
a processor; and
a communication interface configured to communicates with an information processing device that is externally provided, the information processing device implementing a first voice model and a second voice model different from the first voice model,
wherein the processor causes the communication interface to transmit data indicating the pitch specified by the performance unit to the information processing device and receive from the information processing device data generated in accordance with the first voice model and the second voice model that corresponds to the specified pitch, and
wherein the processor synthesizes singing voice based on the data received from the information processing device and causes the synthesized singing voice to output.

12. The electronic musical instrument according to claim 11,
wherein the data received from the information processing device includes a third data that is generated by the information processing device based on a first data output by the first voice model and a second data output by the second voice model, and
wherein the processor synthesizes the singing voice based on the third data received from the information processing device.

13. The electronic musical instrument according to claim 11,
wherein the data received from the information processing device includes a first data output by the first voice model and a second data output by the second voice model in the information processing device, and
wherein the processor in the electronic musical instrument generates a third data based on the first data and the second data received from the information processing device and synthesizes the singing voice based on the generated third data.

14. A method performed by at least one processor in an information processing device, the at least one processor implementing a first voice model and a second voice model different from the first voice model, the method comprising, via the at least one processor:
receiving data indicating a specified pitch; and
causing the first voice model to output a first data and the second voice model to output a second data, and generating and outputting a third data corresponding to the specified pitch based on the first data and second data.

15. The method according to claim 14,
wherein the first voice model includes a trained model that has been trained with a singing voice of a first singer,
wherein the second voice model includes a trained model that has trained with a singing voice of a second singer different from the first singer.

16. The method according to claim 14,
wherein generating of the third data includes performing an interpolation calculation between formant frequencies corresponding to the first data and formant frequencies corresponding to the second data.

17. The method according to claim 14,
wherein the method further includes receiving information on a music piece to be played, and the third data is generated when the information on the music piece indicates that a sound range of the music piece does not correspond to a sound range of the first voice model or a sound range of the second voice model.

18. The method according to claim 14,
wherein the first voice model has a first sound range, and the second voice model has a second sound range different from and not overlapping with the first sound range so that there is a non-overlapping sound range between the first and second sound ranges, and
wherein the third data is generated when the specified pitch belongs to the non-overlapping range.
